(19) United States
(12) Patent Application Publication
(10) Pub. No.: US 2005/0044287 A1
(43) Pub. Date: Feb. 24, 2005

(54) Storage controlling apparatus, storage apparatus and reconnection controlling method in the storage apparatus

(75) Inventors: Shin-ichi Nishizono, Kawasaki (JP); Tohru Kobayashi, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/805,338

(22) Filed: Mar. 22, 2004

(30) Foreign Application Priority Data
Aug. 22, 2003 (JP) 2003-298205

(51) Int. Cl. G06F 3/00

(52) U.S. Cl. 710/15

(57) ABSTRACT

An apparatus having a monitoring means which monitors the number of input/output requests waiting for reconnection, and a switching means which dynamically switches a reconnection request issuing system to be executed by a controlling means to either a first system (one path mode) or a second system (scattering mode), thereby rapidly solving the waiting state when the number of the input/output requests waiting for reconnection is large, while preventing the busy rate of paths from unnecessarily increasing.

### BACKGROUND OF THE INVENTION

1) Field of the Invention

The present invention relates to a technique applied to a storage controlling apparatus controlling an access from a host to a physical device, and a storage apparatus including the storage controlling apparatus and the physical device. Specifically, the present invention relates to a technique for improving a reconnection operation between the host and the storage controlling apparatus (storage apparatus).

2) Description of the Related Art

FIG. 6 is a block diagram showing a structure of a known storage apparatus (storage controlling apparatus). A storage apparatus 1 shown in FIG. 6 writes data from a host 4, or reads out data requested by the host 4 and transfers the data to the host 4 in response to an access (an input/output request; referred to as an I/O request, occasionally) from the host 4 such as a main frame or the like.

The storage apparatus 1 comprises a disk enclosure 2 having a plurality of disk units (disk apparatuses, physical devices) 2a, and a storage controlling apparatus 3 disposed between the disk units 2a and the host 4 to control an access from the host 4.

The storage controlling apparatus 3 comprises a disk interface module 10, a host interface module 20, a management module 30 and a PCI bridge module 40.

The disk interface module 10 controls an interface (data transfer) with each of the disk units 2a in the disk enclosure 2 through a disk interface bus 54.

The host interface module 20 controls an interface (data transfer) with the host 4 through a fiber channel interface bus 50.

The management module 30 generally manages the whole of the storage controlling apparatus 3. The management module 30 is equipped with a cache memory temporarily storing data to be written in one of the disk units 2a from the host 4 or data to be read out from one of the disk units 2a to the host 4, and manages the cache memory.

To the PCI bridge module 40, connected are the disk interface module 10, the host interface module 20 and the management module 30 through PCI buses (interface buses) 51, 52 and 53. Thus, the PCI bridge module 40 connects the disk interface module 10, the host interface module 20 and the management module 30 to one another so that data can be transferred among them.

In the above structure, data writing from the host 4 into one of the disk units 2a and data reading-out from one of the disk units 2a to the host 4 are carried out as follows.

When data is written from the host 4 into one of the disk units 2a in the disk enclosure 2, the data to be written is transferred from the host 4 to the host interface module 20 through the fiber channel interface bus 50, and temporarily stored in the cache memory of the management module 30 from the host interface module 20 via the PCI bridge module 40 through the PCI buses 52 and 53, (refer to an arrow A1 in FIG. 6). After that, the data to be written stored in the cache memory of the management module 30 is transferred to the disk interface module 10 via the PCI bridge module 40 through the PCI buses 53 and 51, and written in a predetermined disk unit 2a from the disk interface module 10 through the disk interface bus 54 (refer to an arrow A2 in FIG. 6).

Conversely, when data is read out from one of the disk units 2a in the disk enclosure 2 to the host 4, the data to be read out is transferred from a disk unit 2a retaining the data to the disk interface module 10 through the disk interface bus 54, and temporarily stored from the disk interface module 10 in the cache memory of the management module 30 via the PCI bridge module 40 through the PCI buses 51 and 53 (refer to an arrow A3 in FIG. 6). After that, the data to be read out stored in the cache memory of the management module 30 is transferred to the host interface module 20 via the PCI bridge module 40 through the PCI buses 53 and 52, and read out to the host 4 from the host interface module 20 through the fiber channel interface bus 50 (refer to an arrow A4 in FIG. 6).

When a data read-out request is notified as an I/O request from a channel (refer to a reference character 4a in FIG. 8) of the host 4 to the storage controlling apparatus 3, the management module 30 has to perform a process (staging) of reading out data to be read out from the disk unit 2a into the cache memory if the data to be read out according to the data read-out request is not retained in the cache memory of the management module 30.

In such case, a communication connected state established between the host 4 and the host interface module 20 is once disconnected. When the data to be read out is read out into the cache memory after that, a reconnection request is issued from the management module 30 to the host 4 through a path, through which the above request has been received, reconnection is performed, then an I/O process corresponding to the above data read-out request is resumed. Such reconnection (re-coupling) is disclosed in patent documents 1 through 4 described hereinafter.

Now, description will be made of a known reconnection operation with reference to a sequence diagram shown in FIG. 7. First, the I/O request (for example, a data read-out request) is notified from the channel (CH) 4a of the host 4 to the management module 30 via the host interface module 20 (refer to arrows A11 and A12). When a waiting time occurs at the time of processing the I/O request (for example, in the case of staging as above), the communication connected state established between the channel 4a of the host 4 and the interface module 20 is once disconnected by the storage controlling apparatus 3.

When the staging of the data to be read out is completed, the management module 30 issues a reconnection request (Req-in request) to the channel 4a of the host 4 through a path, through which the above I/O request has been received (refer to arrows A13 and A14). When receiving the reconnection request, the channel 4a sends back a response to the host interface module 20 (refer to an arrow A15). The host interface module 20 notifies the management module 30 of the received response (refer to an arrow A16).

When the response from the channel 4a is a notice that reconnection succeeds, the management module 30 resumes a process corresponding to the above I/O request with the channel 4a (refer to arrows A17 and A18). When the response from the channel 4a is a notice that the reconnection fails, the management module 30 again carries out (re-tries) the process at and after the arrow A13 shown in FIG. 7.

When data or signals are transferred between the host interface module 20 and the management module 30, the data or signals are transferred via the PCI bridge module 40, in general. In FIG. 7, illustration of the PCI bridge module 40 (namely, illustration of that the data or signals are transferred via the PCI bridge module 40) is omitted.

As the above reconnection, a function called DPR (Dynamic Path Reconnection) is used. The DPR function is a function of dynamically executing reconnection using any one of paths belonging to a path group formed between the host 4 and the storage controlling apparatus 3 (i.e., a path group to which a path, through which the I/O request has been received, belongs) irrespective of the path through which the I/O request has been received when reconnection is carried out between the host 4 (channel 4a) and the storage controlling apparatus 3.

As such DPR function, there are two systems (a first system and a second system) as follows.

In the first system (one path mode), the reconnection request is issued to paths belonging to the same path group one by one through the host interface module 20, and the host interface module 20 is requested to perform the I/O process using a path which succeeds in the reconnection at the point of time that the reconnection succeeds. Namely, the reconnection request is issued to one path, and when the reconnection fails with the path, the reconnection request is issued to another path belonging to the same path group. This procedure is repeated until the reconnection succeeds.

In the second system (scattering mode), the reconnection request is issued to all paths belonging to the same path group through the host interface module 20 concurrently or almost concurrently, and the host interface module 20 is requested to perform the I/O process using a path which first succeeds in the reconnection. Namely, the reconnection request is scattered to all paths forming the same path group, and a path which first succeeds in reconnection is requested to resume the I/O process. Incidentally, other reconnection requests are assigned to the second and later paths. When no request is present, cancel is notified to the paths (host interface module 20).

When a certain path is in the busy state because of another process or because a fault occurs in the path during disconnection, reconnection is possible with another path belonging to the same path group with the above DPR function. As shown in FIG. 8, for example, even when a certain path cannot be reconnected because the path is busy or in trouble (refer to an arrow A22) at the point of time that the disk interface module 10 completes staging of the I/O request (data read-out request) to be reconnected (refer to an arrow A21), another path belonging to the same group is assigned by the management module 30, and reconnection becomes possible with the path (refer to arrows A23 and A24).
[Patent Document 1] Japanese Patent Laid-Open Publication No. SHO 61-003261
[Patent Document 2] Japanese Patent Laid-Open Publication No. HEI 02-148158
[Patent Document 3] Japanese Patent Laid-Open Publication No. HEI 08-083234
[Patent Document 4] Japanese Patent Laid-Open Publication No. 2000-020445

In the above first system (one path mode), when the start (I/O request) of another I/O process and the reconnection request from the host 4 occur at the same time, the reconnection request is withdrawn because the start of the I/O process has generally priority over the reconnection request. The reconnection request thus has to be reissued to another path. In the first system in which the reconnection request is issued one by one, the I/O processing time is prolonged when a number of I/O requests waiting for reconnection are present in the storage controlling apparatus 3. When the start of the I/O process and the reconnection request occur at the same time in such situation, the I/O processing time is largely prolonged (occurrence of subduction phenomenon).

When a number of I/O requests waiting for reconnection are present in the storage controlling apparatus 3, the second system (scattering mode) is very effective because the reconnection request can be efficiently issued. However, when the number of I/O requests waiting for reconnection is small, the busy rate of the paths (channels) is unnecessarily increased, which obstacles the start of a new I/O process.

### SUMMARY OF THE INVENTION

In the light of the above problems, an object of the present invention is to solve the wait state when the number of input/output requests waiting for reconnection is large to prevent the I/O process from being prolonged (subduction), or to suppress an unnecessary increase in busy rate when the number of I/O requests waiting for reconnection is small to prevent the start of a new I/O process from being obstructed, by dynamically switching between the two kinds of DPR system according to the conditions.

The present invention therefore provide a storage controlling apparatus, disposed between a physical device and a host, for controlling an access from the host to the physical device, the storage controlling apparatus comprising one or more host interface modules, connected to a plurality of channels of the host through a plurality of paths belonging to the same path group, for controlling an interface with the host, a management module for generally managing the whole of the apparatus, the management module comprising a reconnection queue for enqueuing information on one or more input/output requests to be reconnected among input/output requests from the channels of the host as control blocks, and managing the enqueued control blocks, a monitoring means for monitoring the number of the enqueued control blocks in the reconnection queue, a controlling means, when an I/O process corresponding to one of the one or more control blocks managed in the reconnection queue is resumed, for controlling resumption of the I/O process in either a first system of issuing a reconnection request to each of the paths belonging to the same path group one by one through the host interface module and requesting the host interface module to perform the I/O process using a path first successful in reconnection at the point of time that the reconnection succeeds, or a second system of issuing concurrently or almost concurrently the reconnection request to the plural paths belonging to the same path group through the one or more host interface modules and requesting the host interface module to perform the I/O process using a path which first succeeds in the reconnection, and a switching means for dynamically switching the system to be executed by the controlling means to either the first system or the second system according to the number of the enqueued control blocks monitored by the monitoring means.

When the number of the enqueued control blocks monitored by the monitoring means is not larger than a predetermined number, the switching means switches the system to be executed by the controlling means to the first system. When the number of the enqueued control blocks monitored by the monitoring means exceeds the predetermined number, the switching means switches the system to be executed by the controlling means to the second system.

The management module may further comprise a management table for managing a use status of each of the paths through the one or more host interface modules, and when the first system is executed, the controlling means may refer to the management table to issue the reconnection request to paths set free in the management table one by one through the host interface module. When said second system is executed, the controlling means may refer to the management table to issue the reconnection request concurrently or almost concurrently to two or more paths set free in the management table through the one or more host interface modules.

When the second system is executed, the controlling means may issue concurrently or almost concurrently the reconnection request to all paths belonging to the same path group through the one or more host interface modules. When the second system is executed, the controlling means successively requests the second and later paths which succeed in the reconnection to perform the I/O processes corresponding to one or more control blocks which can be reconnected among the control blocks managed in the reconnection queue.

The present invention further provides a storage apparatus comprising a physical device and a storage controlling apparatus disposed between the physical device and a host to control an access from the host to the physical device, the storage controlling apparatus comprising one or more host interface modules, connected to a plurality of channels of the host through a plurality of paths belonging to the same path group, for controlling an interface with the host, a management module for generally managing the whole of the storage controlling apparatus, the management module comprising a reconnection queue for enqueuing information on one or more input/output requests to be reconnected among input/output requests from the channels of the host as control blocks, and managing the enqueued control blocks, a monitoring means for monitoring the number of the enqueued control blocks in the reconnection queue, a controlling means, when an I/O process corresponding to one of the one or more control blocks managed in the reconnection queue is resumed, for controlling resumption of the I/O process in either a first system of issuing a reconnection request to each of the paths belonging to the same path group one by one through the host interface module and requesting the host interface module to perform the I/O process using a path first successful in reconnection at the point of time that the reconnection succeeds, or a second system of issuing concurrently or almost concurrently the reconnection request to the plural paths belonging to the same path group through the one or more host interface modules and requesting the host interface module to perform the I/O process using a path which first succeeds in the reconnection, and a switching means for dynamically switching the system to be executed by the controlling means to either the first system or the second system according to the number of the enqueued control blocks monitored by the monitoring means.

The present invention further provides a reconnection controlling method in a storage apparatus comprising a physical device and a storage controlling apparatus disposed between the physical device and a host to control an access from the host to the physical device, comprising the steps of enqueuing information on one or more input/output requests to be reconnected among input/output requests from a plurality of channels of the host as control blocks in a reconnection queue, and managing the enqueued control blocks,monitoring the number of said enqueued control blocks in the reconnection queue, and resuming an I/O process corresponding to one of the one or more control blocks managed in the reconnection queue by dynamically switching, according to the number of the enqueued control blocks, to either a first system of issuing a reconnection request to each of paths belonging to the same path group one by one and requesting to perform the I/O process using a path first successful in reconnection at the point of time that the reconnection succeeds, or a second system of issuing the reconnection request concurrently or almost concurrently to said paths belonging to the same path group and requesting to perform the I/O process using a path which first succeeds in the reconnection.

In the storage controlling apparatus, the storage apparatus and the reconnection controlling method according to this invention, the monitoring means monitors the number of input/output requests waiting for reconnection as the number of control blocks (information on input/output requests to be reconnected among input/output requests from channels of the host) in the reconnection queue, and the switching means switches the system of issuing the reconnection request by the controlling means to either the fist system or the second system according to the number of the enqueued input/output requests. When the number of input/output requests waiting for reconnection is large, the wait state is quickly solved in the second system (scattering mode), thereby to prevent prolongation of the I/O process (subduction). When the number of input/output request waiting for reconnection is small, an unnecessary increase in busy rate of the path is suppressed by means of the first system (one path mode) thereby to certainly prevent the start of a new I/O process from being obstructed.

### BRIEF DESCRIPTION OF THE DRAWINGS

FIG. 1 is a block diagram showing a structure of a storage apparatus (a storage controlling apparatus) according to an embodiment of this invention;

FIG. 2 is a block diagram showing functional structures of essential parts of a management module shown in FIG. 1;

FIG. 3 is a diagram showing practical contents of a host interface module use status management table provided to the management module shown in FIG. 1;

FIG. 4 is a diagram for illustrating a practical operation of a reconnection queue according to the embodiment;

FIG. 5 is a sequence diagram for illustrating a reconnection operation (a reconnection controlling method in the storage apparatus) according to the embodiment;

FIG. 6 is a block diagram showing a structure of a known storage apparatus (a storage controlling apparatus);

FIG. 7 is a sequence diagram for illustrating a known reconnection operation; and

FIG. 8 is a diagram for illustrating a known DPR function.

### DESCRIPTION OF THE PREFERRED EMBODIMENTS

Hereinafter, description will be made of an embodiment of this invention with reference to the drawings.

### [1] Description of an Embodiment of the Invention

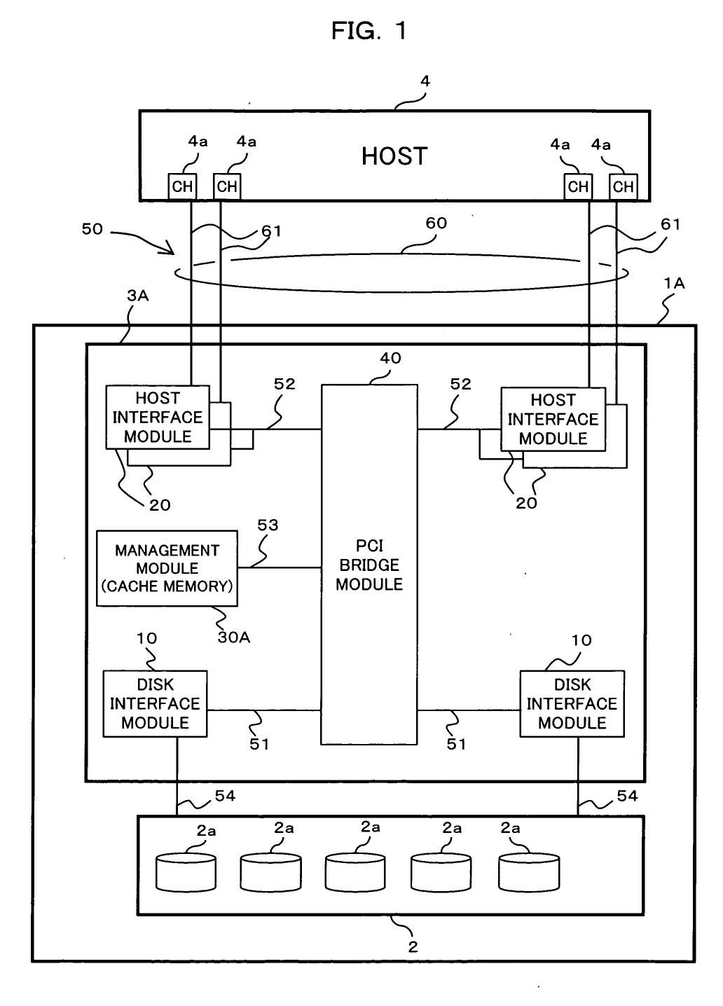

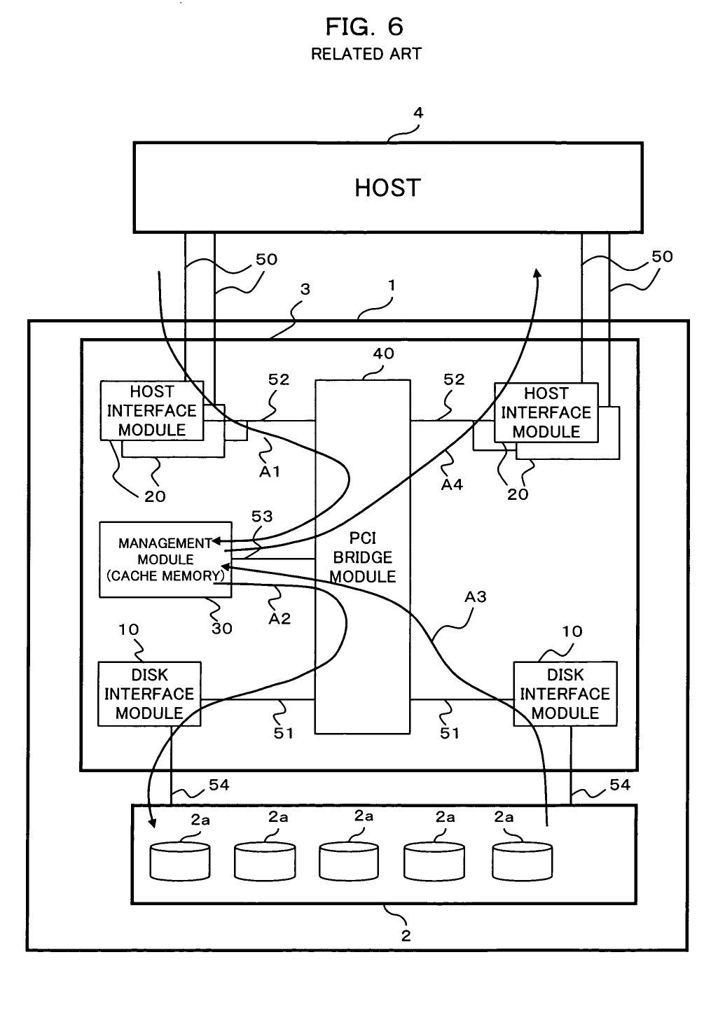

FIG. 1 is a block diagram showing a structure of a storage apparatus (storage controlling apparatus) according to an embodiment of this invention. As shown in FIG. 1, a storage apparatus 1A according to this embodiment is almost similar in structure to the known storage apparatus 1 shown in FIG. 6.

The storage apparatus 1A according to this embodiment writes data from a host 4, or reads out data requested by the host 4 and transfers the data to the host 4, in response to an access from the host 4. The storage apparatus 1A comprises a disk enclosure 2 having a plurality of disk units (magnetic disk units, physical devices) 2a, and a storage controlling apparatus 3A disposed between the disk units 2a and the host 4 to control an access from the host 4 to each of the disk units 2a.

As shown in FIG. 1, the storage controlling apparatus 3A according to this embodiment, basically, comprises a disk interface module 10, a host interface module 20, a management module 30A and a PCI bridge module 40 almost like the known storage controlling apparatus 3 shown in FIG. 6.

The disk interface module 10 controls an interface (data transfer) with each of the disk units 2a in the disk enclosure 2 through a disk interface bus 54.

The host interface module 20 is connected to a plurality (four in this embodiment) of channels 4a of the host 4 through a plurality (four in this embodiment) of paths 61 belonging to the same path group 60 (fiber channel interface bus 50) to control an interface (data transfer) with the host 4. Incidentally, it is possible to provide one host interface module 20 to each of the paths 61, or to a plurality of paths 61.

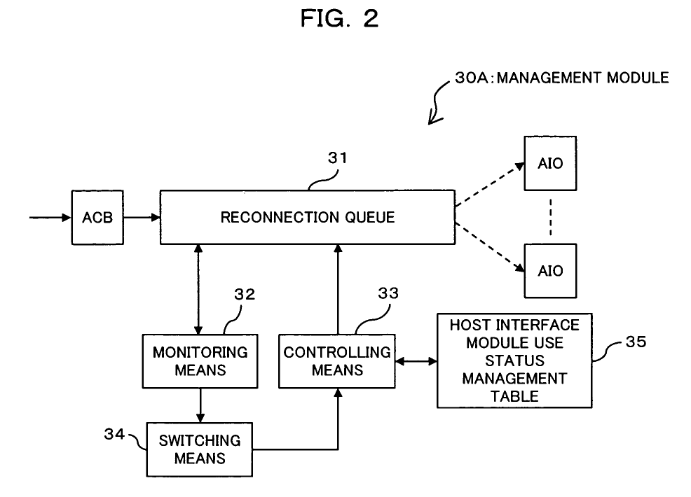

The management module 30A generally manages the whole of the storage controlling apparatus 3A. The management module 30A is equipped with a cache memory temporarily storing data to be written from the host 4 into one of the disk units 2a or data to be read out from one of the disk unit 2a to the host 4, and manages the cache memory. Detailed structure of the management module 30A will be described later with reference to FIG. 2.

To the PCI bridge module, connected are the disk interface module 10, the host interface module 20 and the management module 30A through PCI buses 51, 52 and 53. Accordingly, the PCI bridge module connects the disk interface module 10, the host interface module 20 and the management module 30A to one another so that data can be transferred among them.

In the storage controlling apparatus 3A having the above structure according to this embodiment, data writing from the host 4 into a disk unit 2a and data reading-out from a disk unit 2a to the host 4 are carried out in manners similar to those carried out in the above storage controlling apparatus 3 (refer to the arrow A1 through A4 in FIG. 6).

Next, description will be made of functional structures (functional structures relating to a reconnection operation) of essential parts of the management module 30A according to this embodiment, with reference to a block diagram shown in FIG. 2.

As shown in FIG. 2, the management module 30A comprises a reconnection queue 31, a monitoring means 32, a controlling means 33, a switching means 34 and a host interface module use status management table 35.

The reconnection queue 31 enqueues control blocks [hereinafter referred to as ACBs (Action Control Blocks)] about all I/O requests to be reconnected due to staging process wait, for example, among I/O requests (input/output requests) from the channel 4a of the host 4, and manages the enqueued control blocks. The reconnection queue 31 is provided to each of the management modules 30A. No limitation is specifically placed on the number of enqueued control blocks in the reconnection queue 31.

The monitoring means 32 monitors the number of enqueued ACBs in the reconnection queue 31.

When resuming the I/O process corresponding to an ACB managed in the reconnection queue 31, the controlling means 33 executes issuance of the reconnection request (Req-in request) in the first system (one path mode) or the second system (scattering mode), and controls resumption of the process (I/O process) corresponding to the I/O request.

In the first system (one path mode), as described hereinbefore, the reconnection request is issued to the paths 61 belonging to the same path group 60 one by one through the host interface module 20, and the host interface module 20 is requested to perform the I/O process using a path 61 successful in the reconnection at the point of time that the reconnection succeeds. Namely, the reconnection request is issued to a certain path 61, and when the reconnection does not succeed with the path, the reconnection request is issued to another path 61 belonging to the same path group 60. This procedure is repeated until the reconnection succeeds.

In the second system (scattering mode), the reconnection request is issued concurrently or almost concurrently to each of all paths 61 belonging to the same path group 60 through the host interface module 20, and the host interface module 20 is requested to perform the I/O process using a path 61 which first succeeds in the reconnection, as described hereinbefore. Namely, the reconnection request is scattered to all the paths 61 forming the same path group 60, and a path which first succeeds in the reconnection is requested to resume the I/O process. With regard to the second and later paths 61 which succeed in the reconnection, the controlling means 33 scans the reconnection queue 31 to search for ACBs which can resume the I/O process, and assigns the reconnection requests relating to ACBs which can resume the I/O process to them. When no ACB which can resume the I/O process is present, the controlling means 33 notifies the paths 61 (host interface module 20) of cancellation.

The switching means 34 dynamically switches the issuing system of the reconnection request to be executed by the controlling means 33 to either the first system or second system according to the number of enqueued control blocks (the number of ACBs) monitored by the monitoring means 32. Specifically, the switching means 34 according to this embodiment switches the reconnection request issuing system to be executed by the controlling means 33 to the first system (one path mode) when the number of enqueued control blocks monitored by the monitoring means 32 is not larger than a predetermined number (a threshold value; for example, four). When the number of enqueued control blocks monitored by the monitoring means 32 exceeds the predetermined number, the switching means 34 switches the reconnection request issuing system to be executed by the controlling means 33 to the second system (scattering mode). Even when the number of ACBs in the reconnection queue 31 drops to the threshold value or below immediately after the switching means 34 switches the reconnection request issuing system to the second system, the switching means 34 does not immediately switch the reconnection request issuing system, but maintains the scattering mode of the second system for at least five seconds, for example.

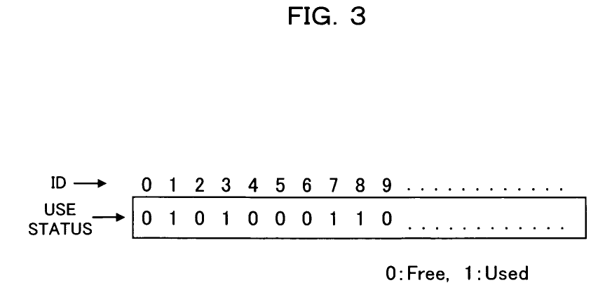

The host interface module use status management table (management table) 35 manages the used/unused state of each of the paths 61 through each of the host interface modules 20. The host interface module use status management table 35 is provided to each of the management modules 30A. In the host interface module use status management table 35, an ID (identification information) of each of the host interface modules 20 is related to used/unused state information on the host interface module 20 (i.e., used/unused state information on a path 61 connected to the host interface module 20), and “1” or “0” is set and retained, as shown in FIG. 3, for example. For instance, when the host interface module 20 is in the free state (unused state), “0” is retained. When the host interface module 20 is in the used state, “1” is retained.

Timings to update the host interface module use status management table 35 are at the points of time that the I/O request is received (“0”→“1”), that the channel 4a and the host interface module 20 are disconnected (“1”→“0”), that the I/O process is completed (“1”→“0”), and that the reconnection request is issued (“0”→“1”). The term “free state” used here represents only a state in which “own management module 30A does not use the host interface module 20,” not assuring that “another management module 30A does not use it as well.”

When one host interface module 20 is provided to one path 61, identification information that can specify a physical host interface module 20 is used as an ID of the host interface module 20. When a plurality of paths 61 are connected to one host interface module 20, identification information that can specify one logical host interface module that can be assumed for each path 61 (logical interface module) is used as an ID of the host interface module 20.

The controlling means 33 refers to the host interface module use status management table 35 described above to issue the reconnection request to a host interface module 20 not used by at least its own management module 30A. For example, when executing the first system (one path mode), the controlling means 33 issues the reconnection request to host interface modules 20 to which the free state “0” is set in the host interface module use status management table 35 one by one. When executing the second system (scattering mode), the controlling means 33 issues the reconnection request concurrently or almost concurrently to two ore more host interface modules 20 to which the free state “0” is set in the host interface module use status management table 35.

Therefore, the management module 30A according to this embodiment does not issue the reconnection request to host interface modules 20 (logical host interface modules) in the used state, but issues the reconnection request to only host interface modules 20 in the free state. When all the host interface modules 20 are in the used state, the management module 30A waits to issue the reconnection request until at least one host interface module 20 is brought to the free state. Namely, each of the management modules 30A does not issue the reconnection request plural times to one host interface modules 20.

Timing to issue the reconnection request from the controlling means 33 to the host interface module 20 is at the point of time that an ACB is enqueued in the queue or that the host interface module 20 is brought to the free state (the unused state). At either point of time, the controlling means 33 scans the reconnection queue 31 from the leading ACB, and checks whether or not any ACB which can be reconnected (can resume the I/O process) is present.

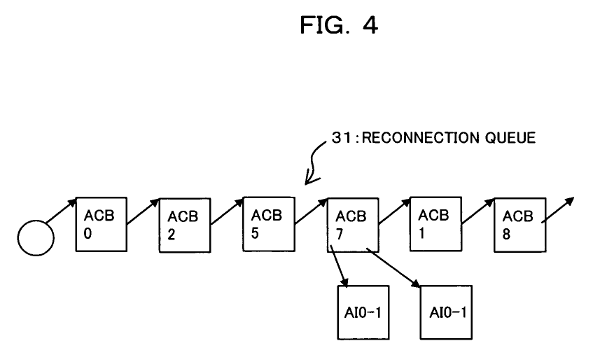

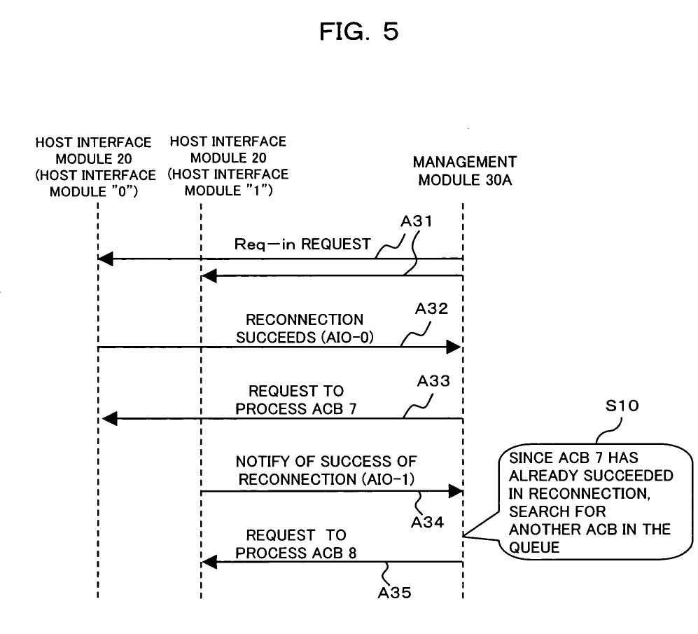

Next, description will be made of the reconnection operation (reconnection controlling method) by the storage apparatus 1A (storage controlling apparatus 3A, management module 30A) structured as above according to this embodiment, with reference to FIGS. 4 and 5. FIG. 4 is a diagram for illustrating a practical operation of the reconnection queue according to this embodiment. FIG. 5 is a sequence diagram for illustrating the reconnection operation (reconnection controlling method in the storage apparatus 1A) according to this embodiment.

A reconnection request (Req-in request) of an ACB retained in the reconnection queue 31 is executed with action input/output blocks (hereinafter referred to as AIOs) prepared by extracting and copying information necessary for the reconnection request from control information in the ACB, as shown in FIG. 4. Namely, the controlling means 33 of the management module 30A acquires AIOs in number equal to the number of host interface modules 20, to which the reconnection request is to be issued, from ACBs to be reconnected in the reconnection queue 31, and issues the reconnection request to each of the host interface modules 20 (each of paths 61) on the basis of each of the AIOs.

According to this embodiment, when the management module 30A is in the high loaded state (for example, the number of ACBs in the reconnection queue 31 monitored by the monitoring means 32 is not less than five), the switching means 34 switches the mode to the second system (scattering mode), and the controlling means 33 acquires as many AIOs as possible in order to issue the reconnection request to as many host interface modules in the free state as possible. When the management module 30A is in the low loaded state (for example, the number of ACBs in the reconnection queue obtained by the monitoring means 32 is not larger than four), the switching means 34 switches the mode to the first system (one path mode), and the controlling means 33 acquires only one AIO in order to issue the reconnection request to one host interface module 20 in the free state, thereby to decrease the busy rate of the channels 4a (paths 61).

When six ACBs, ACB0, ACB2, ACB5, ACB7, ACB1 and ACB8, are managed as ACBs in the reconnection queue 31 as shown in FIG. 4, for example, assuming here that the I/O process relating to ACB 7 is brought to the resumable state, and two host interface modules 20 (their IDs are assumed to be 0 and 1) are in the free state at that point of time (information on this free state being obtained from the host interface module use status management table 35 as described above).

In the above situation, the controlling means 33 acquires two AIOs, AIO-0 and AIO-1, assigned to the two host interface modules 20 (host interface module “0” and host interface module “1”) with respect to ACB 7, as shown in FIG. 4, and issues the reconnection request (Req-in request) to the two host interface modules 20 (host interface module “0” and host interface module “1”) from the management modules 30A on the basis of AIO-0 and AIO-1 (refer to an arrow A31 in FIG. 5).

After that, the reconnection first succeeds with a path 61 between the host interface module “0” and the channel 4a of the host 4, and success of the reconnection is notified from the host interface module “0” to the management module 30A (refer to an arrow A32 in FIG. 5). In response to this, the management module 30A requests the host interface module “0” to resume the I/O process corresponding to ACB 7 (refer to an arrow A33 in FIG. 5).

Following that, the reconnection succeeds with a path 61 between the host interface module “1” and the channel 4a of the host 4, and success of the reconnection is notified from the host interface module “1” to the management module 30A (refer to an arrow A34 in FIG. 5). In response to this, the management module 30A (controlling means 33) scans the reconnection queue 31 to search for another ACB that can resume the I/O process and has the same requester as the I/O request corresponding to ACB 7 (refer to step S10 in FIG. 5). Assuming here that ACB 8 meets this condition, the controlling means 33 requests the host interface module “1” to resume the I/O process corresponding to ACB 8 (refer to an arrow A35 in FIG. 5). When no ACB meeting the above condition is present in the connection queue 31, the controlling means 33 notifies the host interface module “1” of cancellation of the reconnection.

When only one host interface module 20 in the free state is present or when the mode is switched to the first system (one path mode) by the switching means 34, only one AIO is acquired, and the reconnection request is issued to one host interface module 20 in the free state.

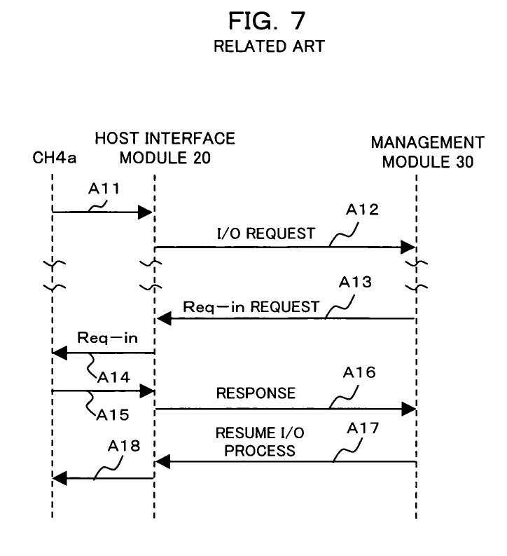

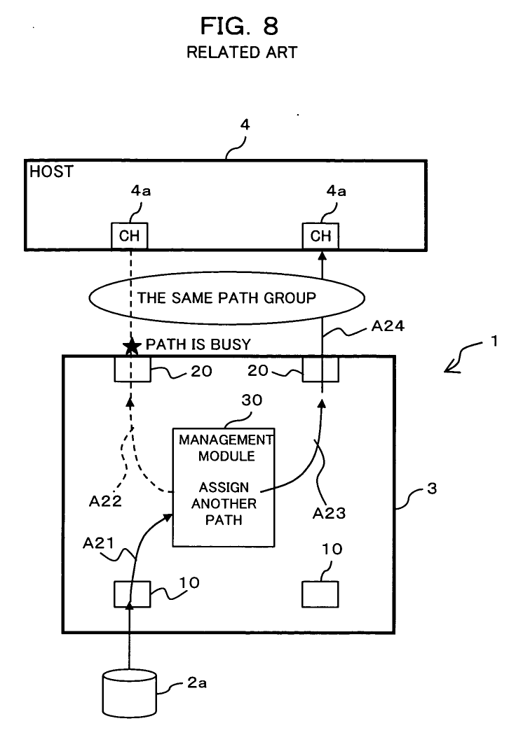

When data or signals are transferred between the host interface module 20 and the management module 30A, the data or signals are normally transferred via the PCI bridge module 40. In FIGS. 5 through 8, illustration of the PCI bridge module 40 is omitted (namely, illustration of that the data or signals are transferred via the PCI bridge module 40 is omitted).

According to this embodiment, in the storage controlling apparatus 3A (in the reconnection controlling method in the storage apparatus 1A), the monitoring means 32 monitors the number of I/O requests waiting for reconnection as the number of ACBs in the reconnection queue 31, and the switching means 34 dynamically switches the method of issuing the reconnection request by the controlling means 33 to the first system (one path mode) or the second mode (scattering mode) according to the number of ACBs.

When the number of I/O requests waiting for reconnection is large (at the time of large load; when the number of ACBs exceeds the threshold value), the reconnection request is issued to a plurality of host interface modules 20 (paths 61) in the free state concurrently or almost concurrently in the second system (scattering mode), so that the waiting state is promptly solved and prolongation (subduction) of the I/O process time is prevented.

When the number of the I/O requests waiting for reconnection is small (at the time of small load; when the number of ACBs is equal to or below the threshold value), the reconnection request is issued to only one host interface module 20 (path 61) even when a plurality of host interface modules in the free state are present, so that unnecessary increase in busy rate of the paths 61 is suppressed and obstruction to the start of a new I/O process is certainly prevented.

### Others

Note that the present invention is not limited to the above embodiment, but may be modified in various ways without departing from the scope of the invention.

For example, the threshold value which is a reference for switching between the first system and the second system is “four” in the above embodiment, but this invention is not limited to this.

The interface between the host 4 and the storage controlling apparatus 3A is a fiber channel interface in the above embodiment, but this invention is not limited to this.

Functions of the monitoring means 32, the controlling means 33 and the switching means 34 in the above embodiment are realized by running a predetermined program by a CPU (Central Processing Unit; not shown) of the management module 30A. This program is provided in a form in which the program is recorded on a computer readable record medium such as flexible disk, CD-ROM, CD-R, CD-RW, DVD or the like, for example. Accordingly, the functions according to this invention (storage controlling apparatus 3A, management module 30A) are accomplished by only changing the software without specifically adding to and/or changing the known hardware. The functions of the reconnection queue 31 and the host interface module use status management table 35 are accomplished by using an area of a memory (not shown) originally provided to the management module 30A.

1. A storage controlling apparatus, disposed between a physical device and a host, for controlling an access from said host to said physical device, said storage controlling apparatus comprising:
one or more host interface modules, connected to a plurality of channels of said host through a plurality of paths belonging to the same path group, for controlling an interface with said host;
a management module for generally managing the whole of said apparatus;
said management module comprising:
a reconnection queue for enqueuing information on one or more input/output requests to be reconnected among input/output requests from said channels of said host as control blocks, and managing said enqueued control blocks;
a monitoring means for monitoring the number of said enqueued control blocks in said reconnection queue;
a controlling means, when an I/O process corresponding to one of said one or more control blocks managed in said reconnection queue is resumed, for controlling resumption of said I/O process in either a first system of issuing a reconnection request to each of said paths belonging to the same path group one by one through said host interface module and requesting said host interface module to perform said I/O process using a path first successful in reconnection at the point of time that the reconnection succeeds, or a second system of issuing concurrently or almost concurrently the reconnection request to said plural paths belonging to the same path group through said one or more host interface modules and requesting said host interface module to perform said I/O process using a path which first succeeds in the reconnection; and
a switching means for dynamically switching the system to be executed by said controlling means to either said first system or said second system according to the number of the enqueued control blocks monitored by said monitoring means.

2. The storage controlling apparatus according to claim 1, wherein when the number of the enqueued control blocks monitored by said monitoring means is not larger than a predetermined number, said switching means switches the system to be executed by said controlling means to said first system, and when the number of the enqueued control blocks monitored by said monitoring means exceeds said predetermined number, said switching means switches the system to be executed by said controlling means to said second system.

3. The storage controlling apparatus according to claim 1, wherein said management module further comprises a management table for managing a use status of each of said paths through said one or more host interface modules, and when said first system is executed, said controlling means refers to said management table to issue the reconnection request to paths set free in said management table one by one through said host interface module.

4. The storage controlling apparatus according to claim 2, wherein said management module further comprises a management table for managing a use status of each of said paths through said one or more host interface modules, and when said first system is executed, said controlling means refers to said management table to issue the reconnection request to paths set free in said management table one by one through said host interface module.

5. The storage controlling apparatus according to claim 1, wherein said management module further comprises a management table for managing a use status of each of said paths through said one or more host interface modules, and when said second system is executed, said controlling means refers to said management table to issue the reconnection request concurrently or almost concurrently to two or more paths set free in said management table through said one or more host interface modules.

6. The storage controlling apparatus according to claim 2, wherein said management module further comprises a management table for managing a use status of each of said paths through said one or more host interface modules, and when said second system is executed, said controlling means refers to said management table to issue the reconnection request concurrently or almost concurrently to two or more paths set free in said management table through said one or more host interface modules.

7. The storage controlling apparatus according to claim 3, wherein said management module further comprises a management table for managing a use status of each of said paths through said one or more host interface modules, and when said second system is executed, said controlling means refers to said management table to issue the reconnection request concurrently or almost concurrently to two or more paths set free in said management table through said one or more host interface modules.

8. The storage controlling apparatus according to claim 4, wherein said management module further comprises a management table for managing a use status of each of said paths through said one or more host interface modules, and when said second system is executed, said controlling means refers to said management table to issue the reconnection request concurrently or almost concurrently to two or more paths set free in said management table through said one or more host interface modules.

9. The storage controlling apparatus according to claim 1, wherein when said second system is executed, said controlling means successively requests the second and later paths which succeed in the reconnection to perform the I/O processes corresponding to one or more control blocks which can be reconnected among said control blocks managed in said reconnection queue.

10. A storage apparatus comprising:
a physical device; and
a storage controlling apparatus disposed between said physical device and a host to control an access from said host to said physical device;
said storage controlling apparatus comprising:
one or more host interface modules, connected to a plurality of channels of said host through a plurality of paths belonging to the same path group, for controlling an interface with said host;
a management module for generally managing the whole of said storage controlling apparatus;
said management module comprising:
a reconnection queue for enqueuing information on one or more input/output requests to be reconnected among input/output requests from said channels of said host as control blocks, and managing said enqueued control blocks;
a monitoring means for monitoring the number of said enqueued control blocks in said reconnection queue;
a controlling means, when an I/O process corresponding to one of said one or more control blocks managed in said reconnection queue is resumed, for controlling resumption of said I/O process in either a first system of issuing a reconnection request to each of said paths belonging to the same path group one by one through said host interface module and requesting said host interface module to perform said I/O process using a path first successful in reconnection at the point of time that the reconnection succeeds, or a second system of issuing concurrently or almost concurrently the reconnection request to said plural paths belonging to the same path group through said one or more host interface modules and requesting said host interface module to perform said I/O process using a path which first succeeds in the reconnection; and
a switching means for dynamically switching the system to be executed by said controlling means to either said first system or said second system according to the number of the enqueued control blocks monitored by said monitoring means.

11. The storage apparatus according to claim 10, wherein when said the number of the enqueued control blocks monitored by said monitoring means is not larger than a predetermined number, said switching means switches the system to be executed by said controlling means to said first system, and when the number of the enqueued control blocks monitored by said monitoring means exceeds said predetermined number, said switching means switches the system to be executed by said controlling means to said second system.

12. The storage apparatus according to claim 10, wherein said management module further comprises a management table for managing a use status of each of said paths through said one or more host interface modules, and when said first system is executed, said controlling means refers to said management table to issue the reconnection request to paths set free in said management table one by one through said host interface module.

13. The storage apparatus according to claim 11, wherein said management module further comprises a management table for managing a use status of each of said paths through one or more said host interface modules, and when said first system is executed, said controlling means refers to said management table to issue the reconnection request to paths set free in said management table one by one through said host interface module.

14. The storage apparatus according to claim 10, wherein said management module further comprises a management table for managing a use status of each of said paths through said one or more host interface modules, and when said second system is executed, said controlling means refers to said management table to issue the reconnection request concurrently or almost concurrently to two or more paths set free in said management table through said one or more host interface modules.

15. The storage apparatus according to claim 11, wherein said management module further comprises a management table for managing a use status of each of said paths through said one or more host interface modules, and when said second system is executed, said controlling means refers to said management table to issue the reconnection request concurrently or almost concurrently to two or more paths set free in said management table through said one or more host interface modules.

16. The storage apparatus according to claim 12, wherein said management module further comprises a management table for managing a use status of each of said paths through said one or more host interface modules, and when said second system is executed, said controlling means refers to said management table to issue the reconnection request concurrently or almost concurrently to two or more paths set free in said management table through said one or more host interface modules.

17. The storage apparatus according to claim 13, wherein said management module further comprises a management table for managing a use status of each of said paths through said one or more host interface modules, and when said second system is executed, said controlling means refers to said management table to issue the reconnection request concurrently or almost concurrently to two or more paths set free in said management table through said one or more host interface modules.

18. The storage apparatus according to claim 10, wherein when said second system is executed, said controlling means successively requests the second and later paths which succeed in the reconnection to perform the I/O processes corresponding to one ore more control blocks which can be reconnected among said control blocks managed in said reconnection queue.

19. A reconnection controlling method in a storage apparatus comprising a physical device and a storage controlling apparatus disposed between said physical device and a host to control an access from said host to said physical device, comprising the steps of:
enqueuing information on one or more input/output requests to be reconnected among input/output requests from a plurality of channels of said host as control blocks in a reconnection queue, and managing said enqueued control blocks;
monitoring the number of said enqueued control blocks in said reconnection queue; and
resuming an I/O process corresponding to one of said one or more control blocks managed in said reconnection queue by dynamically switching, according to the number of said enqueued control blocks, to either a first system of issuing a reconnection request to each of paths belonging to the same path group one by one and requesting to perform the I/O process using a path first successful in reconnection at the point of time that the reconnection succeeds, or a second system of issuing the reconnection request concurrently or almost concurrently to said paths belonging to the same path group and requesting to perform the I/O process using a path which first succeeds in the reconnection.

20. The reconnection controlling method in a storage apparatus according to claim 19, wherein when the number of said enqueued control blocks is not larger than a predetermined number, said first system is switched to, and when the number of said enqueued control blocks exceeds said predetermined number, said second system is switched to.

21. The reconnection controlling method in a storage apparatus according to claim 19, wherein a use status of each of said paths is managed in a management table; and
when said first system is executed, the reconnection request is issued to paths set free in said management table one by one.

22. The reconnection controlling method in a storage apparatus according to claim 20, wherein a use status of each of said paths is managed in a management table; and
when said first system is executed, the reconnection request is issued to paths set free in said management table one by one.

23. The reconnection controlling method in a storage apparatus according to claim 19, wherein a use status of each of said paths is managed in a management table; and
when said second system is executed, the reconnection request is issued concurrently or almost concurrently to two or more paths set free in said management table.

24. The reconnection controlling method in a storage apparatus according to claim 20, wherein a use status of each of said paths is managed in a management table; and
when said second system is executed, the reconnection request is issued concurrently or almost concurrently to two or more paths set free in said management table.

25. The reconnection controlling method in a storage apparatus according to claim 21, wherein a use status of each of said paths is managed in a management table; and
when said second system is executed, the reconnection request is issued concurrently or almost concurrently to two or more paths set free in said management table.

26. The reconnection controlling method in a storage apparatus according to claim 22, wherein a use status of each of said paths is managed in a management table; and
when said second system is executed, the reconnection request is issued concurrently or almost concurrently to two or more paths set free in said management table.

27. The reconnection controlling method in a storage apparatus according to claim 19, wherein when said second system is executed, the second and later paths which succeed in the reconnection are requested to perform the I/O processes corresponding to one or more control blocks which can be reconnected among said control blocks managed in said reconnection queue.
